(19) United States
(12) Patent Application Publication
(10) Pub. No.: US 2026/0028246 A1
(43) Pub. Date: Jan. 29, 2026

(54) PREPARATION OF HEXAGONAL CLOSE-PACKED (2H) RHODIUM AND RHODIUM ALLOY NANOMATERIALS

(71) Applicant: The Chinese University of Hong Kong, Hong Kong (CN)

(72) Inventors: Ye CHEN, Hong Kong (CN); Long ZHENG, Hong Kong (CN); Chenhao SHU, Hong Kong (CN)

(21) Appl. No.: 19/280,242

(22) Filed: Jul. 25, 2025

Related U.S. Application Data
(60) Provisional application No. 63/675,447, filed on Jul. 25, 2024.

(51) Int. Cl. C01G 55/00; C22C 5/00

(52) U.S. Cl. CPC C01G 55/00; C22C 5/00; C01P 2002/20; C01P 2002/72; C01P 2002/82; C01P 2002/85; C01P 2004/04; C01P 2004/24; C01P 2004/51; C01P 2004/64

(57) ABSTRACT

A compounds-derived method for synthesizing Rh and 2H Rh-based alloy nanomaterials is provided. The method includes preparing orthorhombic phase Rh₂C NPLs; obtaining pure 2H Rh NPLs by extracting C atoms from the Rh₂C NPLs; and obtaining 2H Rh-based alloy NPLs by simultaneously reducing the second metal during the C extraction. The preparing orthorhombic phase Rh₂C NPLs includes dissolving Rh(acac)₃ or RhCl₃ into a mixture solution containing oleylamine and oleic acid in a container and sonicating for a predetermined time; adding formaldehyde into the mixture solution; sealing the container and sonicating it; heating the container; and cooling the container to room temperature. Obtaining pure 2H Rh NPLs by extracting C atoms from the Rh₂C NPLs includes re-dispersing the Rh₂C NPLs in oleylamine by sonication; and heating the solution in an oil bath, while simultaneously flowing Ar/H₂ mixture into the solution. Obtaining 2H Rh-based alloy NPLs by simultaneously reducing the second metal during the C extraction includes re-dispersing the Rh₂C NPLs and dissolving a second metal precursor in oleylamine by sonication; and heating the solution in an oil bath, while simultaneously flowing Ar/H₂ mixture into the solution. The pure 2H Rh NPLs obtained remain stable after annealing treatment at 300° C. for one hour under an inert atmosphere.

### CROSS-REFERENCE TO RELATED APPLICATION

The present application claims the benefit of U.S. Provisional Application Ser. No. 63/675,447, filed Jul. 25, 2024, which is hereby incorporated by reference herein in its entirety, including any figures, tables, or drawings.

### BACKGROUND OF THE INVENTION

Rhodium (Rh) nanomaterials exhibit excellent catalytic properties and have attracted numerous research interests from both academia and industry due to their great potentials in various applications, including the traditional automotive industry, electric vehicles, and the fine chemical industry.

Recent advancements in phase engineering of nanomaterials (PEN) have sparked considerable attention in synthesizing and studying the properties of noble metal nanomaterials, particularly Rh nanomaterials with unconventional phases. Despite notable progress, achieving pure hexagonal close-packed (hcp, 2H type) Rh nanomaterials remains elusive. Current efforts have led only to the synthesis of 2H/face-centered cubic (fcc, or 3C) heterophase Rh nanomaterials, such as 2H/3C Rh nanoparticles (Rong Yu, et al., J. Am. Chem. Soc. 2017, 139, 575), 2H/3C Au@Rh core-shell nanosheets (Hua Zhang, et al., J. Am. Chem. Soc. 2021, 143, 4387), and 2H/3C Pd@Rh core-shell nanostructures (Hua Zhang, et al., Nat Sci. 2022; 2: e20220026). These findings underscore the significant challenges in synthesizing pure 2H Rh nanomaterials, as there have been no reports of successful preparation of pure 2H Rh nanomaterials.

With the development of PEN, crystal phase of nanomaterials has been recognized as an important parameter to modulate their physicochemical properties. The 2H structure is an unconventional crystal phase of Rh, in which the close-packed plane follows a characteristic “ABAB” stacking along the [0001] h crystallographic direction. However, pure 2H Rh nanomaterials have not yet been reported.

In addition, there are only a few reports of synthesized 2H-containing heterophase Rh nanomaterials, where the 2H content was low and uncontrolled. It remains very difficult to prepare template-free, high-phase-purity Rh nanocrystals with the unconventional 2H phase. Therefore, it is of great importance to develop new pathways or recipes for synthesizing 2H Rh nanomaterials and then to investigate their phase-dependent catalytic properties.

### BRIEF SUMMARY OF THE INVENTION

There continues to be a need in the art for improved designs and techniques for a method for preparing 2H Rh nanoplates (NPLs).

According to an embodiment of the subject invention, a compounds-derived method for synthesizing pure 2H Rh and 2H Rh-based alloy nanomaterials is provided. The method comprises preparing orthorhombic phase Rh₂C NPLs, obtaining pure 2H Rh NPLs by extracting C atoms from the Rh₂C NPLs, and obtaining 2H Rh-based alloy NPLs by simultaneously reducing a second metal during the C extraction. The preparing orthorhombic phase Rh₂C NPLs comprises dissolving a first predetermined amount of Rh(acac)₃ or RhCl₃ into a mixture solution containing a second predetermined amount of oleylamine and a third predetermined amount of oleic acid in a container and sonicating for a first predetermined time; adding a fourth predetermined amount of formaldehyde into the mixture solution; sealing the container and sonicating it for a second predetermined time; heating the container at a first predetermined temperature for a third predetermined time; and cooling the container to room temperature. The method may further comprise collecting the resultant products by centrifugations at 14000 rpm for 5 minutes; washing the resultant products one or more times with a mixture of cyclohexane and ethanol (v/v=1:2); and dispersing the resultant products in cyclohexane. Moreover, the obtaining pure 2H Rh NPLs by extracting C atoms from the Rh₂C NPLs comprises re-dispersing the Rh₂C NPLs in a fifth predetermined amount of oleylamine by sonication; and heating the solution in an oil bath at a second predetermined temperature for a fourth predetermined time, while simultaneously flowing Ar/H₂ mixture with a first predetermined percentage of H₂ volume content bubbled into the solution at a first predetermined flow rate. The obtaining 2H Rh-based alloy NPLs comprises re-dispersing the Rh₂C NPLs and dissolving a sixth predetermined amount of a first predetermined metal precursor in the fifth predetermined amount of oleylamine by sonication; and heating the solution in an oil bath at a third predetermined temperature for a fifth predetermined time, while simultaneously flowing Ar/H₂ mixture with the first predetermined percentage of H₂ volume content bubbled into the solution at the first predetermined flow rate. The first predetermined amount may be in a range of 1-3 mg. The second predetermined amount may be about 2.25 mL. The third predetermined amount may be in a range of 0.1-0.3 mL. The first predetermined time may be about 5 minutes. The fourth predetermined amount may be in a range of 0.7-0.8 mL. The second predetermined time may be in range of 5-10 minutes. The first predetermined temperature is in a range of 160-200° C. The third predetermined time may be about 12 hours. The fifth predetermined amount may be in a range of 2.0-4.0 mL. The second predetermined temperature may be in a range of 130-160° C. The fourth predetermined time may be in a range of 16-24 hours. The first predetermined percentage may be about 10%. The first predetermined flow rate may be about 50 ml/minute. The sixth predetermined amount may be in a range of 0.1-1 mg. The first predetermined metal precursor may be Ru precursor or Pt precursor. The third predetermined temperature may be in a range of 140-200° C. The fifth predetermined time may be in a range of 14-20 hours. Furthermore, the resultant 2H Rh NPLs can be configured to have an edge length in the range of 5-50 nm, an edge width in the range of 2-20 nm, and a thickness of about 1-4 nm. The elemental composition of the resultant 2H Rh-based alloy NPLs includes RhRu and RhPt.

### BRIEF DESCRIPTION OF THE DRAWINGS

FIG. 1 is a schematic representation of the transformation process of orthorhombic rhodium carbide (Rh₂C) nanocrystals with different morphology and size to hexagonal close-packed (hcp, 2H type) Rh nanoplates (NPLs) and face-centered cubic (fcc, or 3C) Rh nanoflowers (NFs), according to an embodiment of the subject invention.

FIGS. 2A-2G show characterization of orthorhombic Rh₂C NPLs, wherein FIG. 2A is a low magnification transmission electron microscopy (TEM) image, and FIG. 2B is X-ray diffraction (XRD) pattern image of orthorhombic Rh₂C NPLs, wherein the insets in FIG. 2A and FIG. 2B are a schematic representation of an orthorhombic Rh₂C NPL and a schematic representation of unit cell of an orthorhombic Rh₂C NPL, respectively, wherein FIG. 2C is an atomic-resolution aberration-corrected high-angle annular dark-field scanning transmission electron microscopy (HAADF-STEM) image of a representative Rh₂C NPL from the front view, wherein FIG. 2D is a magnified image taken from the selected area in FIG. 2C with FIG. 2E showing corresponding fast Fourier transform (FFT) pattern, wherein FIG. 2F is an image showing simulated crystal structure projected along zone axis based on the orthorhombic phase with FIG. 2G showing corresponding simulated FFT pattern, wherein the simulated data of orthorhombic Rh₂C based on the reported lattice parameters of a=3.0768 Å, b=4.7671 Å, and c=4.7227 Å (J. Am. Chem. Soc. 2020, 142, 1247), according to an embodiment of the subject invention.

FIGS. 3A-3B. FIG. 3A shows a size distribution histogram of edge width for orthorhombic Rh₂C NPLs measured from FIG. 2A, and FIG. 3B shows a size distribution histogram of edge length for orthorhombic Rh₂C NPLs measured from FIG. 2A, according to an embodiment of the subject invention.

FIGS. 4A-4J show characterization of 2H Rh NPLs, wherein FIG. 4A is a low magnification HAADF-STEM image, FIG. 4B is an image of selected area electron diffraction (SAED), and FIG. 4C shows the XRD pattern of 2H Rh NPLs, wherein the inset in FIG. 4A is schematic illustration of a 2H Rh NPL, FIG. 4D is an atomic-resolution aberration-corrected HAADF-STEM image of a representative 2H Rh NPL from the front view, FIG. 4E is a magnified image taken from the selected area in FIG. 4D with FIG. 4F showing corresponding FFT pattern, wherein the inset in FIG. 4F is a regular hexagonal dashed line, FIG. 4G is an atomic-resolution aberration-corrected HAADF-STEM image of a representative 2H Rh NPL supported on the C nanotube from the side view with a thickness of 2.3 nm, FIG. 4H is a magnified image taken from the selected area in FIG. 4G with FIG. 4I showing corresponding FFT pattern, FIG. 4J show crystallographic models illustrating the top view (left panel) and side views (top and right panels) of a 2H Rh NPL, wherein the close-packed planes along the [0001]ₕ direction show a characteristic stacking sequence of ABAB, the simulated XRD pattern of orthorhombic Rh₂C is based on the reported lattice parameters of a=3.0768 Å, b=4.7671 Å, and c=4.7227 Å (J. Am. Chem. Soc. 2020, 142, 1247), the simulated XRD pattern of 2H Rh is based on the lattice parameters of a=b=2.706 Å, c=4.394 Å, the XRD pattern of 3C Rh is based on the data of PDF #05-0685, according to an embodiment of the subject invention.

FIGS. 5A-5B. FIG. 5A shows a size distribution histogram of edge width for 2H Rh NPLs measured from FIG. 4A, and FIG. 5B shows a size distribution histogram of edge length for 2H Rh NPLs measured from FIG. 4A, according to an embodiment of the subject invention.

FIGS. 6A-6F show thickness measurement of 2H Rh NPLs, wherein FIG. 6A is a low magnification TEM image of 2H Rh NPLs supported on C nanotubes, wherein FIGS. 6B-6E are high-resolution TEM (HRTEM) images of different 2H Rh NPLs supported on C nanotubes from side views, wherein FIG. 6F are bar charts showing thickness statistics of 2H Rh NPLs measured from FIGS. 6B-6E and FIG. 4G, according to an embodiment of the subject invention.

FIGS. 7A-7C show characterization of orthorhombic Rh₂C NFs, wherein FIG. 7A is a low magnification TEM image, wherein FIG. 7B is a XRD pattern image, and wherein FIG. 7C is a size distribution histogram of orthorhombic Rh₂C NFs, wherein the inset in FIG. 7A is schematic illustration of a typical orthorhombic Rh₂C NF, wherein the simulated XRD pattern of orthorhombic Rh₂C is based on the reported lattice parameters of a=3.0768 Å, b=4.7671 Å, and c=4.7227 Å (J. Am. Chem. Soc. 2020, 142, 1247), according to an embodiment of the subject invention.

FIGS. 8A-8C show characterization of 3C Rh NFs, wherein FIG. 8A is a low magnification TEM image, wherein FIG. 8B is a XRD image, and wherein FIG. 8C is SAED pattern of 3C Rh NFs, wherein the insets in FIG. 8A is schematic illustration of a 3C Rh NF and a size distribution histogram, wherein the simulated XRD pattern of orthorhombic Rh₂C is based on the reported lattice parameters of a=3.0768 Å, b=4.7671 Å, and c=4.7227 Å (J. Am. Chem. Soc. 2020, 142, 1247), wherein the XRD pattern of 3C Rh is based on the data of PDF #05-0685, according to an embodiment of the subject invention.

FIG. 9 shows crystal structure characterization of single 3C Rh NF, wherein FIG. 9A is a low magnification TEM image of single 3C Rh NF, wherein FIGS. 9B1, 9C1, 9D1 are HRTEM images of the selected areas (marked as b,c,d, respectively) in FIG. 9A with their corresponding FFT patterns shown in FIGS. 9B2, 9C2, and 9D2, according to an embodiment of the subject invention.

FIGS. 10A-10E show coordination environment and chemical state characterization of 2H Rh NPLs, 3C Rh NFs, and orthorhombic Rh₂C NPLs, wherein FIG. 10A shows Rh K-edge X-ray absorption near edge structure (XANES) and FIG. 10B shows Fourier-transformed Rh k³-weight K-edge extended X-ray absorption fine structure (EXAFS) spectra of Rh bulk foil, orthorhombic Rh₂C NPLs, 2H Rh NPLs, 3C Rh NFs, and Rh₂O₃ powder, wherein the inset in FIG. 10A shows enlarged XANES spectra taken from the selected area wherein FIG. 10A, wherein FIG. 10C is a X-ray photoelectron spectroscopy (XPS) image and wherein FIG. 10D is an enlarged XPS spectra image taken from the selected area in FIG. 10C of orthorhombic Rh₂C NPLs, 2H Rh NPLs, and 3C Rh NFs, and wherein FIG. 10E shows the unit cell of 2H Rh nanocrystal with lattice parameters a=b=2.706 Å, c=4.394 Å, respectively, according to an embodiment of the subject invention.

FIGS. 11A-11C. FIG. 11A shows low-frequency Raman spectrum of orthorhombic Rh₂C NPLs, FIG. 11B shows low-frequency Raman spectrum of 2H Rh NPLs, and FIG. 11C shows low-frequency Raman spectrum of 3C Rh NFs, according to an embodiment of the subject invention.

FIGS. 12A-12B. FIG. 12A shows the XRD patterns of Rh₂C NPLs-derived products with different reaction time of extracting C and FIG. 12B shows the XRD patterns of Rh₂C NFs-derived products with different reaction time of extracting C, wherein the simulated XRD pattern of orthorhombic Rh₂C is based on the reported lattice parameters of a=3.0768 Å, b=4.7671 Å, and c=4.7227 Å (J. Am. Chem. Soc. 2020, 142, 1247), wherein the simulated XRD pattern of 2H Rh is based on the lattice parameters of a=b=2.706 Å, c=4.394 Å, and wherein the XRD pattern of 3C Rh is based on the data of PDF #05-0685, according to an embodiment of the subject invention.

FIG. 13 shows results of the thermostability study of crystal structure for 2H Rh NPLs, wherein XRD patterns of 2H Rh NPLs supported on C powder after annealing treatment at different temperatures ranging from 300° C. to 700° C. under 10% H₂ in Ar gas flow for 1 hour, and it is noted that the broadened peak at around 44° C. on the XRD pattern of Rh/C-700° C. attributes to the graphited C support. The XRD pattern of 3C Rh is based on the data of PDF #05-0685, and the simulated XRD pattern of 2H Rh is based on the lattice parameters of a=b=2.706 Å, c=4.394 Å, according to an embodiment of the subject invention.

FIGS. 14A-14H show results of the thermostability study of morphology and crystal structure for 2H Rh NPLs, wherein low magnification TEM images of 2H Rh NPLs supported on C powder after the annealing treatment at 300° C. (FIG. 14A), 400° C. (FIG. 14B), 500° C. (FIG. 14C), 600° C. (FIG. 14D) with corresponding HRTEM image of single 2H/3C heterophase Rh NP (FIG. 14E), 700° C. (FIG. 14F) with corresponding HRTEM image (FIG. 14G) of single 3C Rh NP under 10% H₂ in Ar gas flow with 1 hour, wherein the inset in FIG. 14G shows corresponding FFT pattern, wherein FIG. 14H is schematic illustration of the transform process from single 2H Rh NPL to 2H/3C heterophase Rh NP to 3C Rh nanoparticle (NP), according to an embodiment of the subject invention.

FIGS. 15A-15D show structure and composition characterizations of 2H RhRu NPLs, wherein FIG. 15A is a low magnification TEM image, FIG. 15B is an image of SAED, FIG. 15C is energy dispersive X-ray spectroscopy (EDS) elemental mapping images of Ru, Rh and their overlapped image, and FIG. 15D is line scans across three 2H RhRu NPLs, wherein the formation of the RhRu alloy is confirmed, according to an embodiment of the subject invention.

FIGS. 16A-16C show structure and composition characterizations of 2H RhPt NPLs, wherein FIG. 16A is a low magnification TEM image, FIG. 16B is an image of SAED, and FIG. 16C is line scans across a 2H RhPt NPL, wherein the formation of the RhPt alloy is confirmed, according to an embodiment of the subject invention.

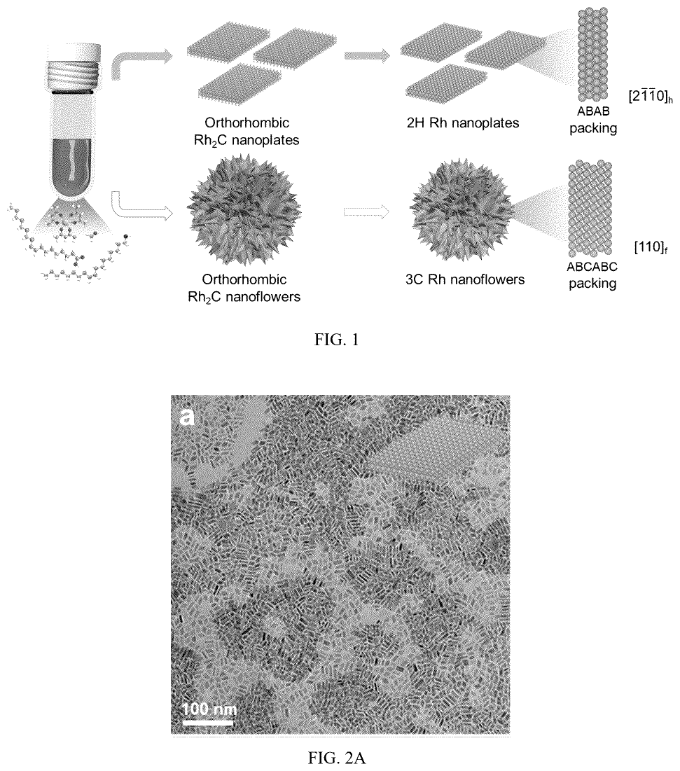

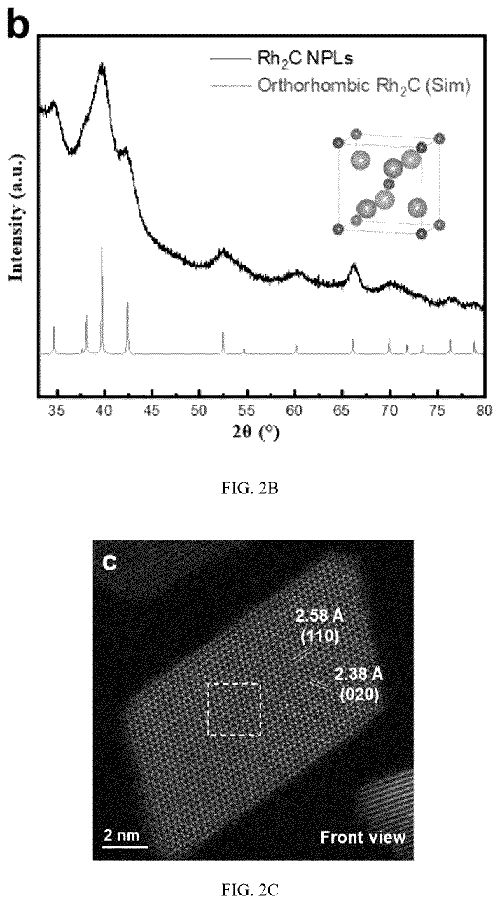

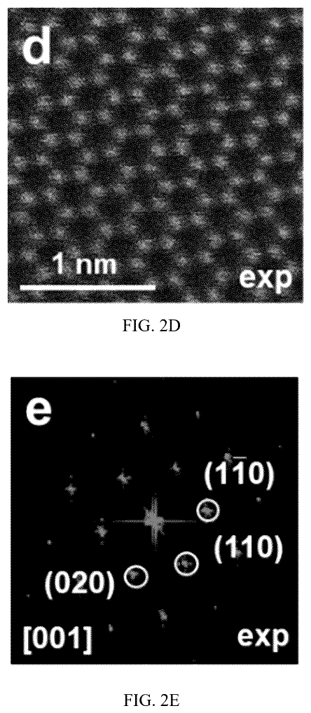

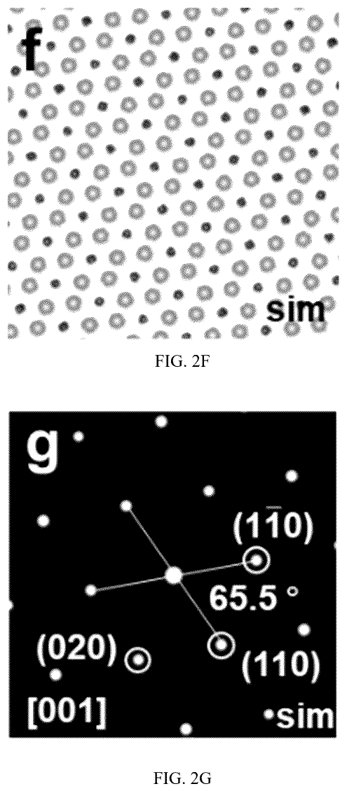

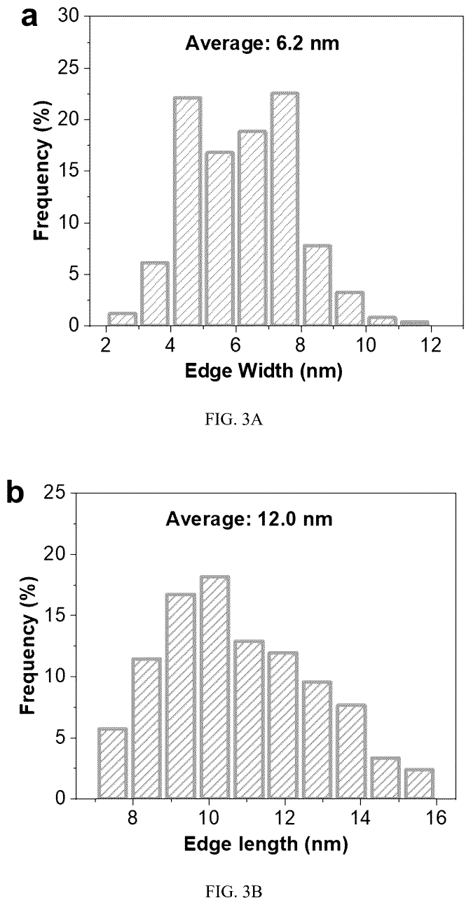

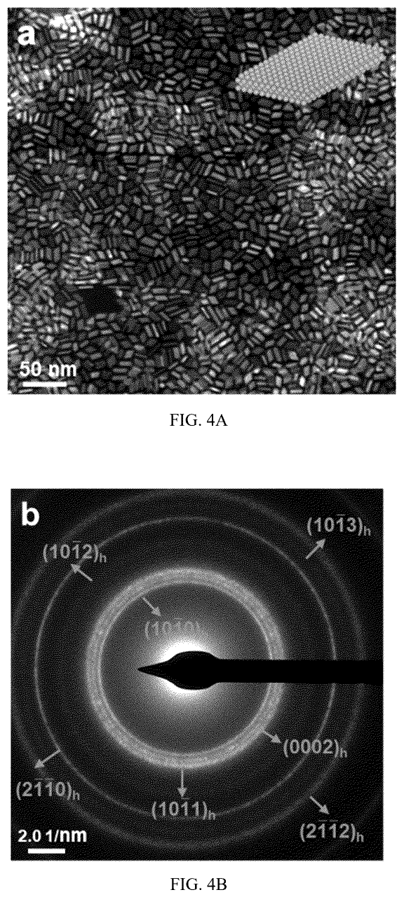

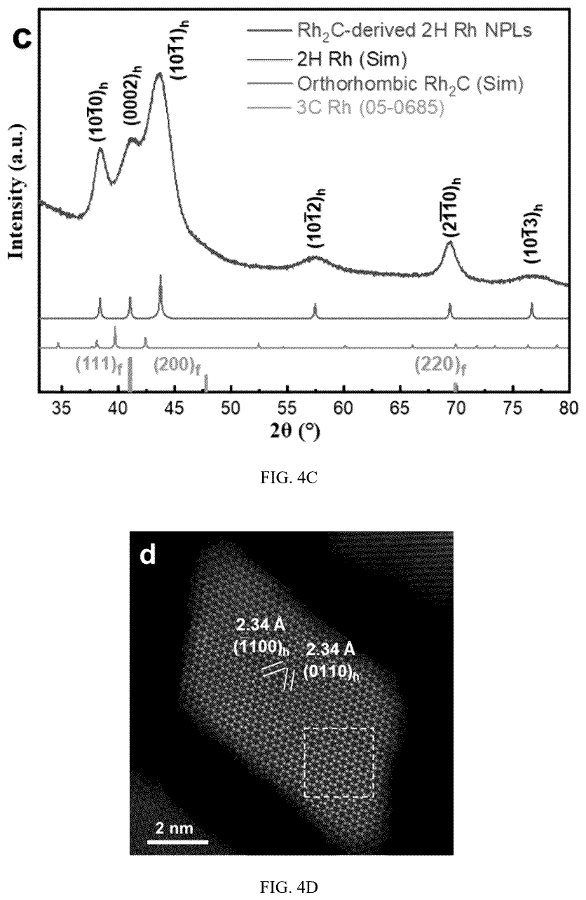

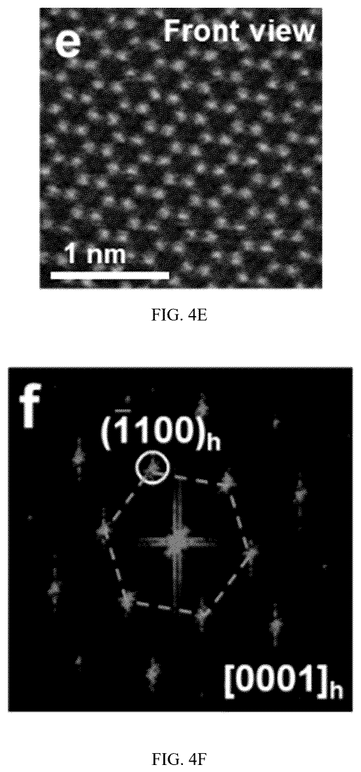

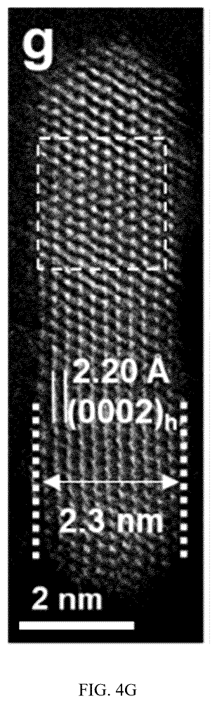

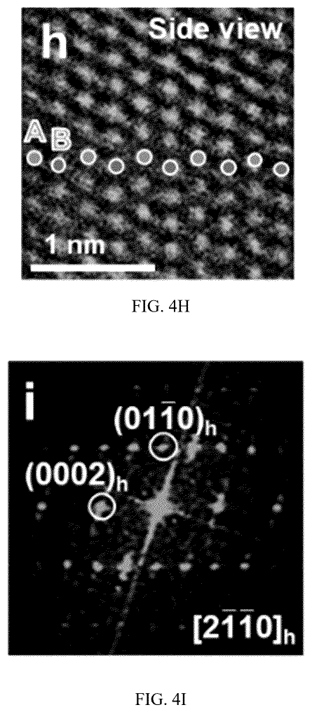

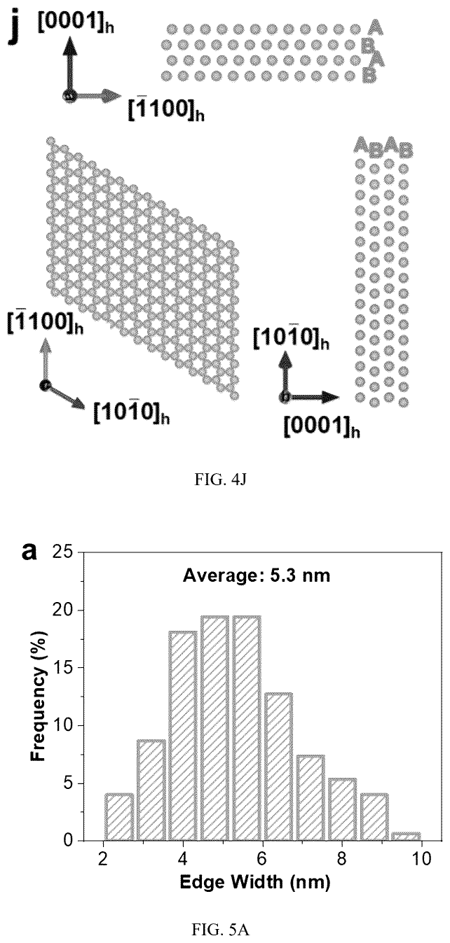

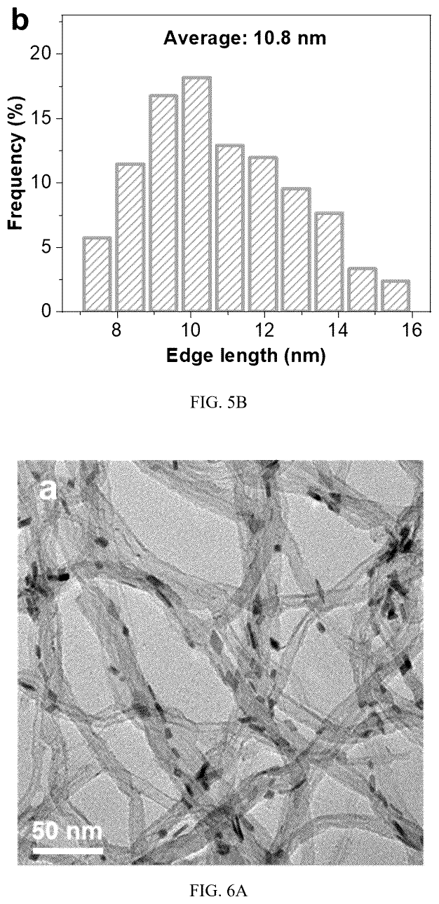

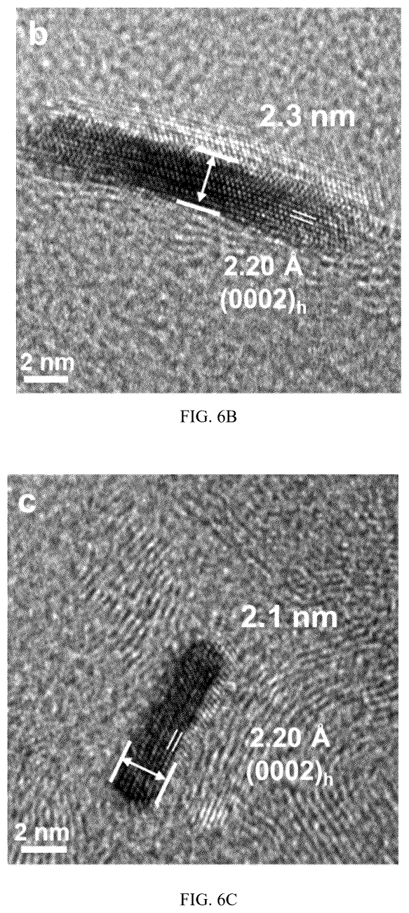

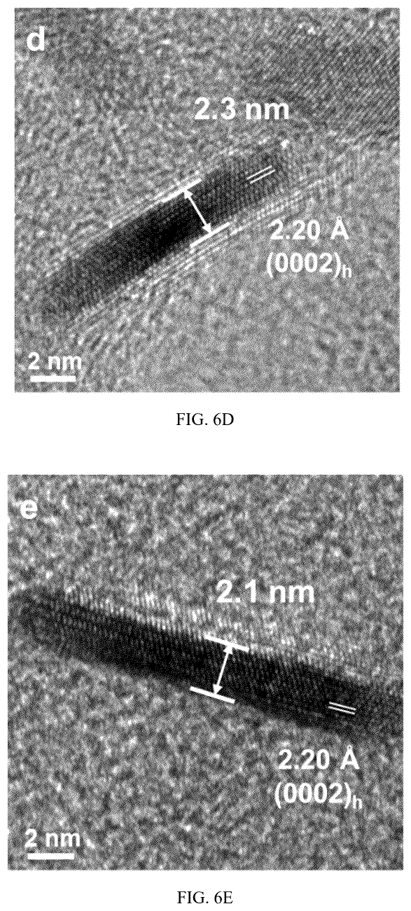

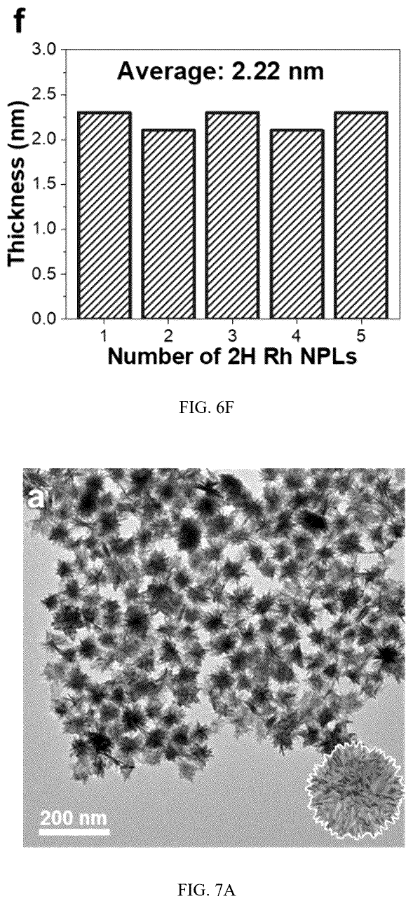

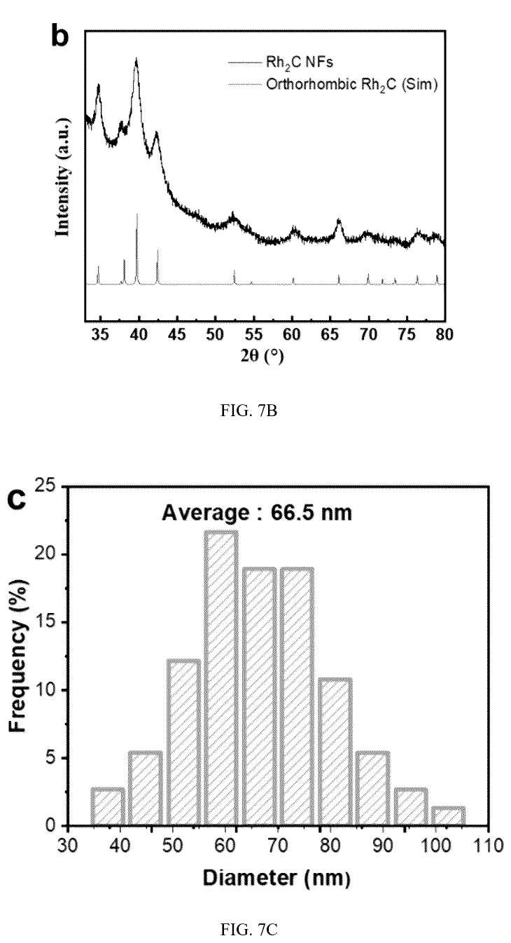

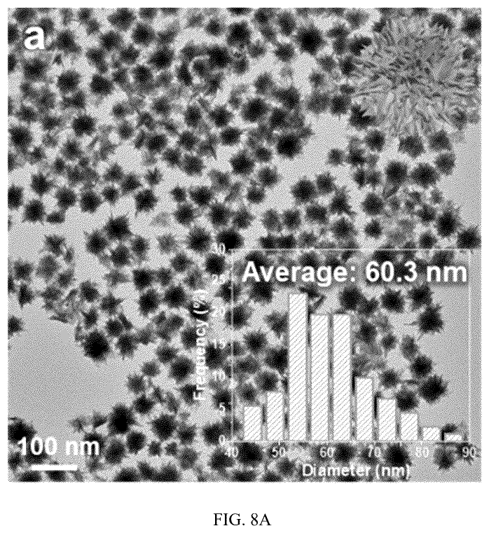

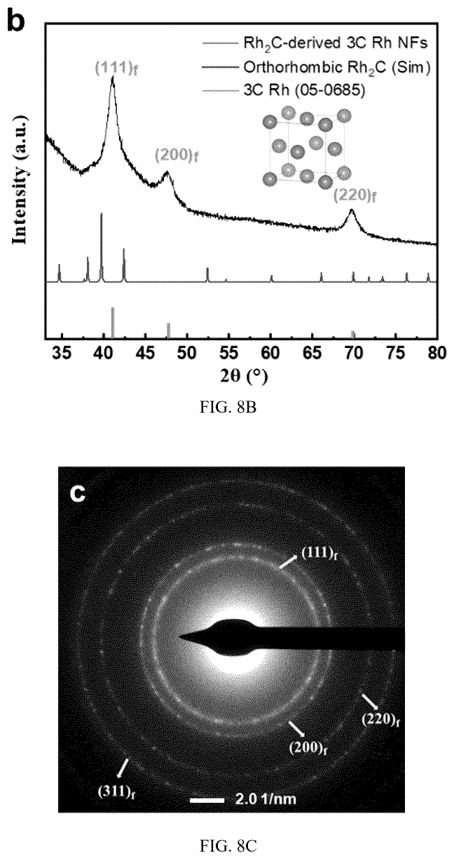

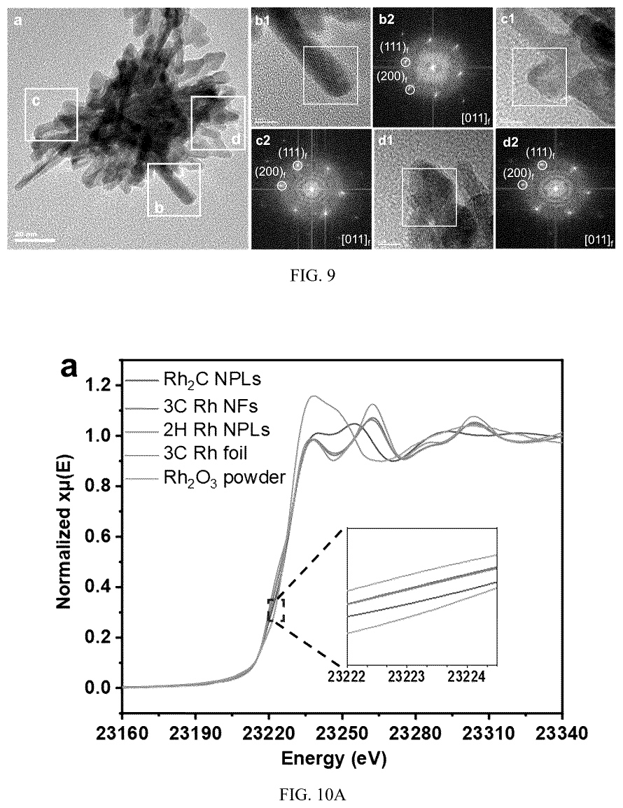

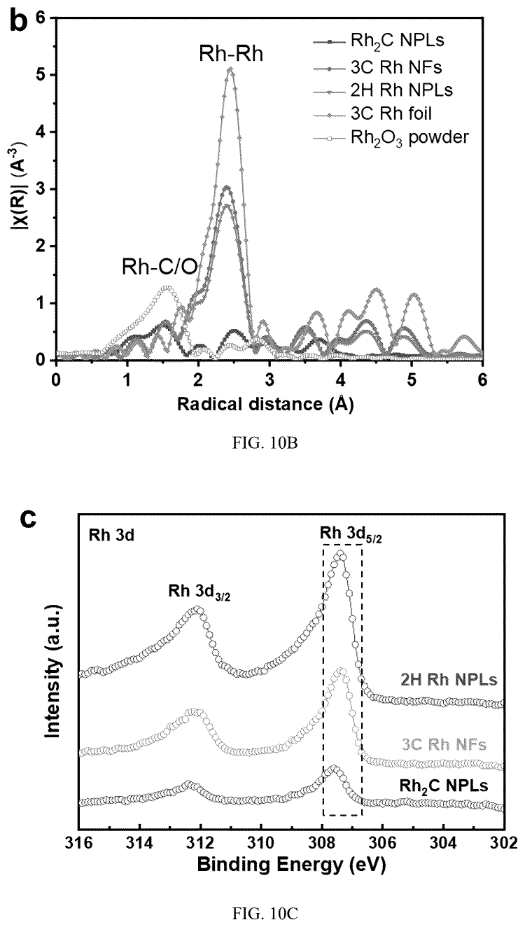

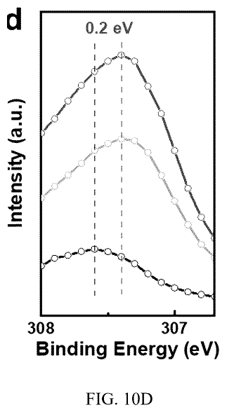

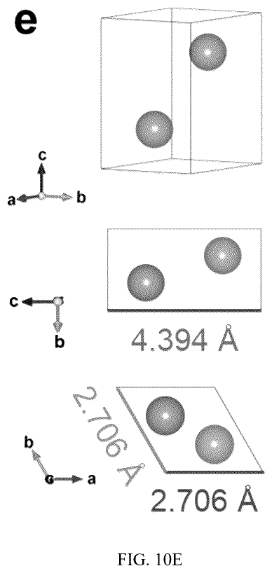

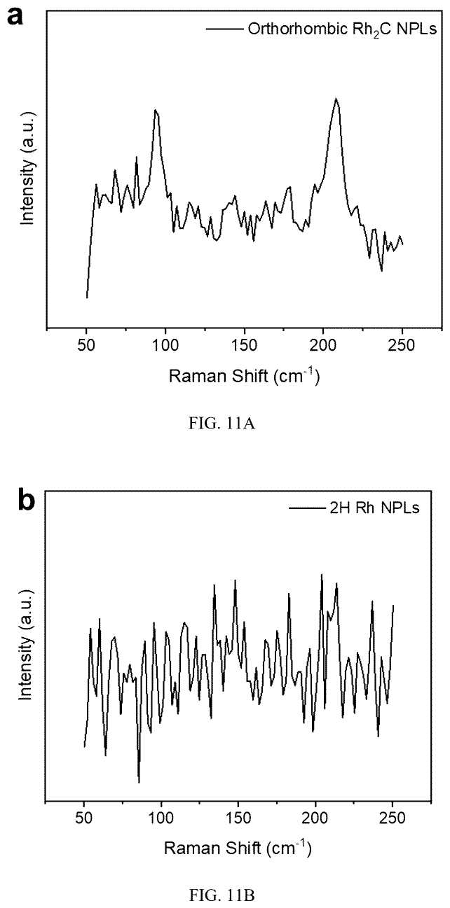

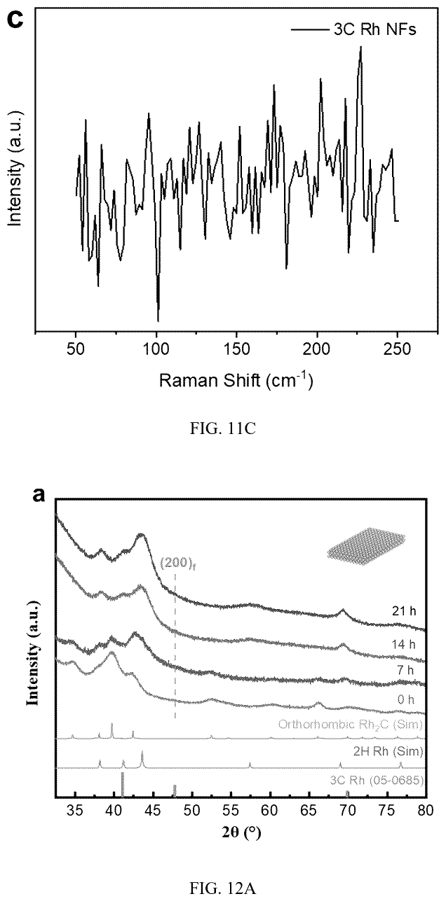

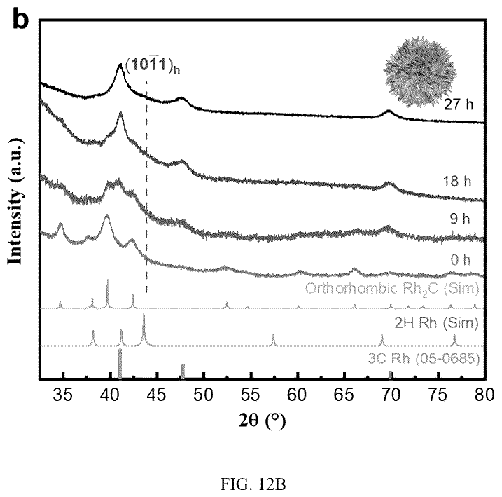

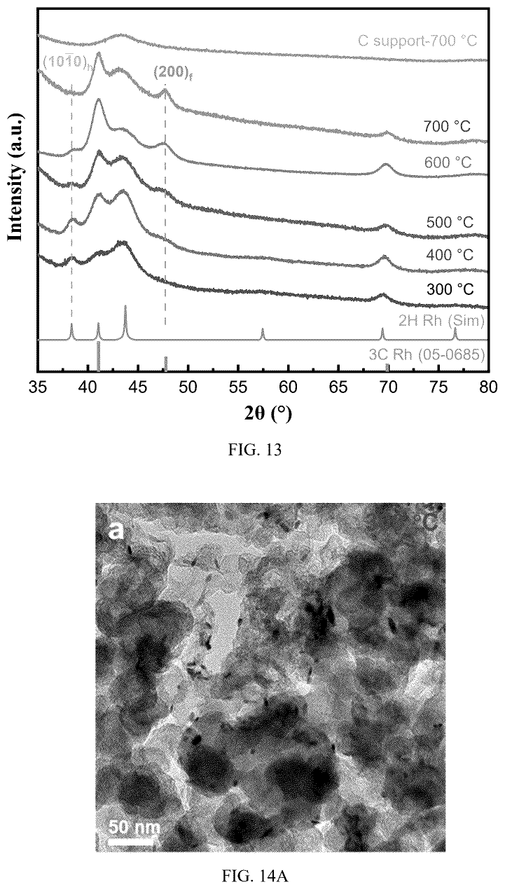

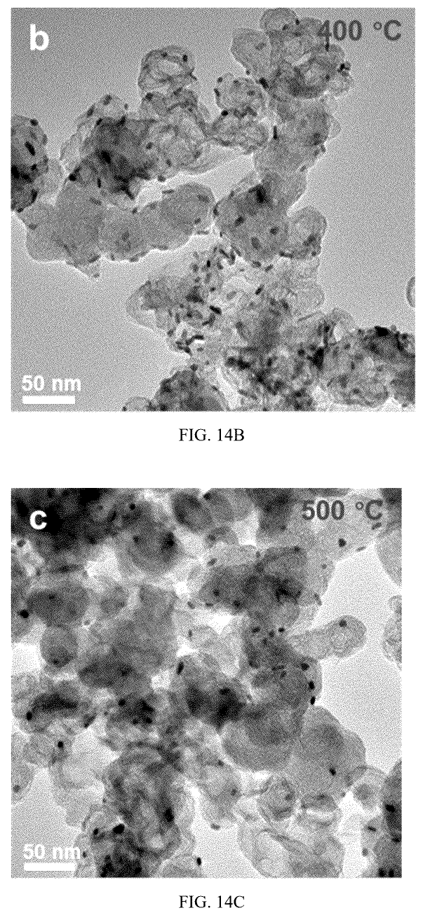

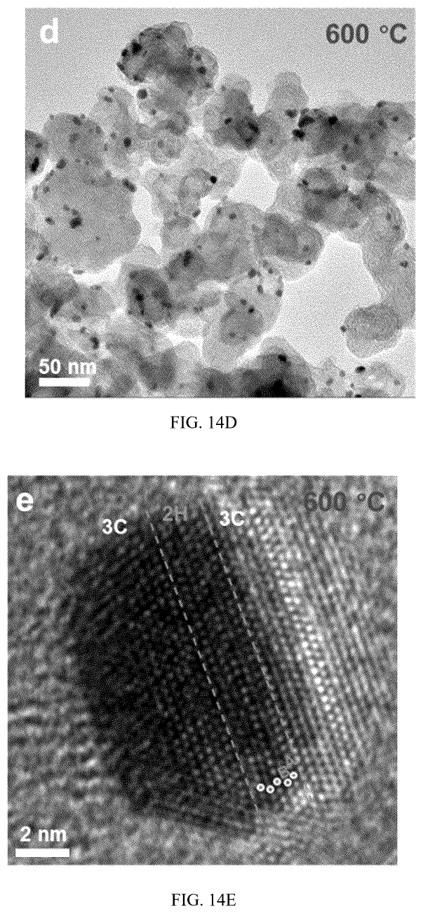

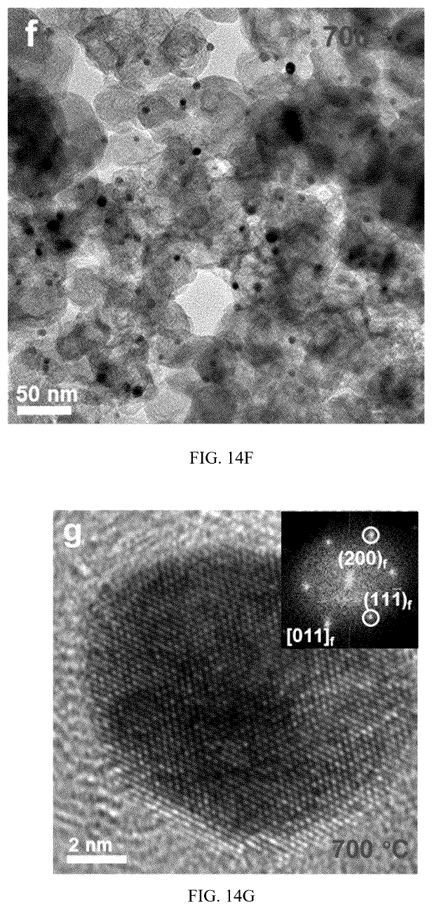

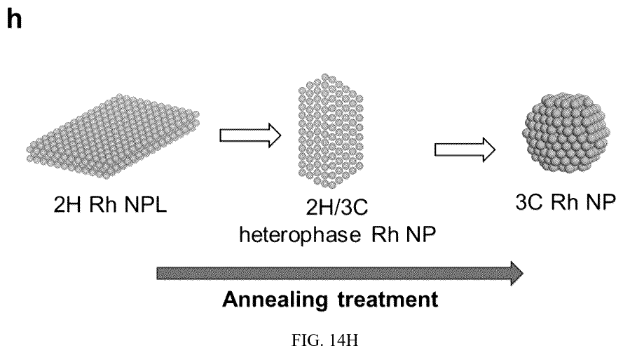

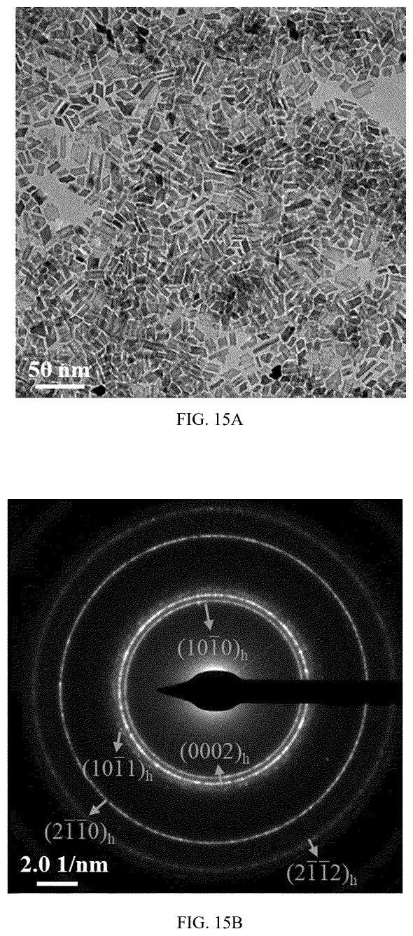

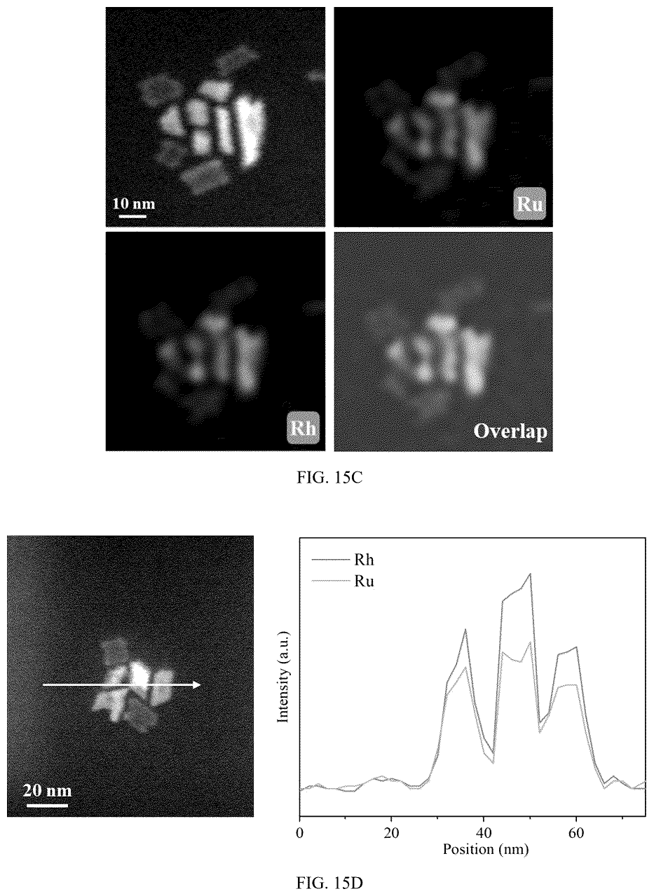

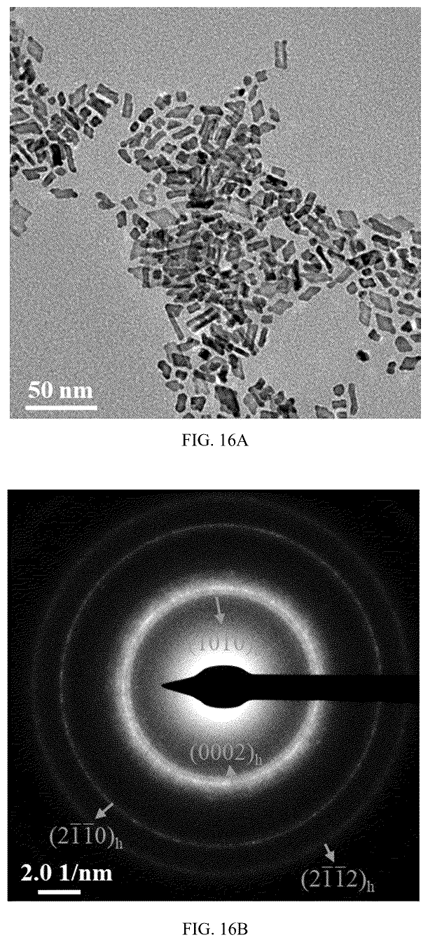

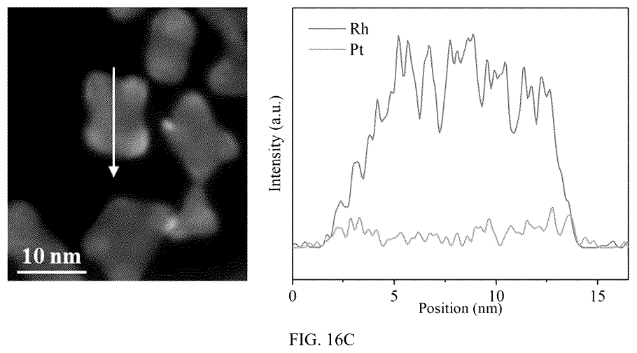

### DETAILED DISCLOSURE OF THE INVENTION

Embodiments of the subject invention are directed to a compounds-derived method for synthesizing 2H Rh nanomaterials.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Investigating the catalytic properties of metal nanomaterials with unconventional phases holds great promise for developing new materials and techniques that advance energy conversion, catalysis, and other applications. However, synthesizing metal nanomaterials with high-purity unconventional phases remains a significant challenge. For instance, pure 2H Rh nanomaterials have not yet been successfully prepared.

A compounds-derived method is provided to synthesize pure 2H Rh and 2H Rh-based alloy nanomaterials via a two-step method. Specifically, the orthorhombic phase Rh₂C NPLs are first prepared. Then, pure 2H Rh NPLs are obtained by extracting C atoms from the Rh₂C NPLs, and 2H Rh-based alloy NPLs are obtained by simultaneously reducing the second metal during the C extraction. Importantly, the 2H Rh NPLs have excellent thermostability, and the 2H phase and two-dimensional (2D) morphology can be maintained at 300° C. with 1 hour under inert atmosphere. This suggests that they could be applicable in a variety of industrial conditions, such as the traditional automotive industry, electric vehicles, and the fine chemical industry. Moreover, this compounds-derived method can also provide guidance for the synthesis of other nanomaterials with unconventional phases.

In the first step of synthesis, orthorhombic phase Rh₂C NPLs are prepared by first dissolving 1-3 mg of Rh(acac)₃ or RhCl₃ into the mixture solution containing 2.25 mL oleylamine and 0.1-0.3 mL oleic acid in a glass pressure tube by sonicating about 5 minutes. Then 0.7-0.8 mL of formaldehyde is added into the above solution. Next, the glass pressure tube is sealed and sonicated for 5-10 minutes. Then, the glass pressure tube is put into an oven and kept undisturbed at 160-200° C. for 12 hours, followed by natural cooling down to the room temperature. The resultant products are collected by centrifugations at 14000 rpm for 5 minutes, being washed three times with a mixture of cyclohexane and ethanol (v/v=1:2), and finally, being dispersed in cyclohexane.

In the second step of synthesis, the 2H phase Rh NPLs are obtained by extracting C atoms from Rh₂C compounds. In particular, the pre-synthesized Rh₂C NPLs are re-dispersed in 2.0-4.0 mL oleylamine by sonication in a three-neck flask. Then the solution is heated in an oil bath at 130-160° C. for 16-24 hours. At the same time, an Ar/H₂ mixture flow with 10% H₂ volume content is constantly bubbled into the solution with a flow speed of 50 ml/minute. The resultant products are collected by centrifugations at 14000 rpm for 5 minutes, washed three times with a mixture of cyclohexane and ethanol (v/v=1:2), and finally, dispersed in cyclohexane. The 2H phase Rh-based alloy NPLs are obtained by simultaneously reducing the second metal during the C extraction. In particular, the pre-synthesized Rh₂C NPLs and 0.1-1 mg Ru (acac) 3 or Pt (acac) 2 are dissolved in 2.0-4.0 mL oleylamine by sonication in a three-neck flask. Then the solution is heated in an oil bath at 140-200° C. for 14-20 hours. At the same time, an Ar/H₂ mixture flow with 10% H₂ volume content is constantly bubbled into the solution with a flow speed of 50 ml/minute. The resultant products are collected by centrifugations at 14000 rpm for 5 minutes, washed three times with a mixture of cyclohexane and ethanol (v/v=1:2), and finally, dispersed in cyclohexane. Note that Ru precursors can be substituted by RuCl₃, and Pt precursors can be substituted by H₂PtCl₆.

In the control experiment, larger size orthorhombic phase Rh₂C NFs are prepared by decreasing the amount of formaldehyde to 0.25 ml in the recipe of synthesis of orthorhombic phase Rh₂C NPLs while keeping other conditions constant. In addition, Rh₂C NFs-derived 3C Rh NFs are obtained with the similar C extraction method applied for the 2H Rh NPLs with longer reaction time (for example, 27-32 hours).

The compounds-derived method is provided for preparing pure 2H Rh and 2H Rh-based alloy NPLs with high yield. In addition, the 2H Rh NPLs have an ultrasmall size with a uniform shape and excellent thermostability.

Comparison with Existing Technologies

Some literatures related to the synthesis of orthorhombic Rh₂C nanocompounds and 2H/3C heterophase Rh nanomaterials are listed below and are compared with the embodiments of the subject invention.
1. In the previous report “Formation of Hexagonal-Close Packed (HCP) Rhodium as a Size Effect” (Rong Yu, J. Am. Chem. Soc. 2017, 139, 575), 2H/3C heterophase Rh nanoparticles were synthesized by solvothermal reaction or by electron-beam induced decomposition of Rh monolayers. However, the 2H signal is too low to be detected in the powder XRD pattern, in which strong 3C signals can be observed, indicating the existence of abundant 3C by-products.
   In contrast, according to the embodiments of the subject inventions, a compounds-derived method is developed to synthesize 2H Rh NPLs, achieving high yield and phase purity. Furthermore, the phase-related properties of Rh are systematically analyzed for the electrocatalytic reaction, revealing their inherent mechanisms.
2. In the previous report “Selective Epitaxial Growth of Rh Nanorods on 2H/fcc Heterophase Au Nanosheets to Form 1D/2D Rh—Au Heterostructures for Highly Efficient Hydrogen Evolution” (Hua Zhang, J. Am. Chem. Soc. 2021, 143, 4387), the 2H/3C heterophase Rh shells were formed by epitaxially growing on the square-like 2H/3C heterophase Au nanosheets. Since 2H/3C heterophase Au templates were dominantly in 3C phase, the dominant crystal phase of the deposited Rh shells was also 3C. The 2H/3C heterophase Au@Rh core-shell nanosheets showed enhanced activity toward hydrogen evolution reaction (HER) in the acid electrolyte, superior to the commercial 3C Rh/C, indicating the great potential of unconventional phase Rh to catalytic applications.
3. 2D/0D hierarchical heterostructures prepared via facet-selective epitaxial growth of triangular Rh nanoplates on 2H—Pd nanoparticles. Nat. Sci. 2022; 2: e20220026. Prof. Hua Zhang's group reported the 2H/3C heterophase Rh shells by epitaxially growing on the pure 2H Pd nanoparticles. Due to the facet-selective epitaxial growth of Rh shells, 3C Rh was obtained when growing on the (0002) n facets of 2H Pd seeds while 2H Rh was prepared when depositing on other facets of 2H Pd seeds, resulting in the 2H/3C heterophase Rh shells. The 2H/3C heterophase Pd@Rh core-shell nanostructures showed promising HER activity in the alkaline electrolyte, superior to the commercial 3C Rh/C.
   Different from the method reported in the literatures 2 and 3, according to the embodiments of the subject inventions, a method is developed to synthesize template-free pure 2H Rh NPLs with high yield, possessing great potentials toward phase-boosted catalytic applications.
4. Rational Synthesis for a Noble Metal Carbide. J. Am. Chem. Soc. 2020, 142, 1247. Prof. Hiroshi Kitagawa's group reported the synthesis of orthorhombic Rh₂C nanocompounds by solvothermal reaction. However, the morphology of the Rh₂C nanocrystals is irregular and the size distribution is not uniform. In their work, they extracted C atoms from the Rh₂C compounds by heating Rh₂C supported on C powders at 150° C. for 2 h under a 1 atm H₂ atmosphere in tube furnace. However, only 3C Rh nanomaterials were obtained.
   Different from this work, according to the embodiments of the subject inventions, the reaction conditions can be tuned to control the morphology and sizes of Rh₂C nanocompounds, resulting in larger size Rh₂C NFs and Rh₂C NPLs. In addition, it is found that the sizes and morphology of Rh₂C compounds play important roles in determining the crystal phase of Rh₂C-derived Rh nanomaterials. When extracting C atoms from larger size Rh₂C NFs, 3C Rh NFs are obtained. However, when extracting C atoms from Rh₂C NPLs, 2H Rh NPLs can be synthesized. These findings provide guidance for the preparation of nanomaterials with unconventional phases.
5. Evoking ordered vacancies in metallic nanostructures toward a vacated Barlow packing for high-performance hydrogen evolution. Sci. Adv. 2021, 7, eabd6647. Prof. Hua Zhang's group reported the synthesis of C-doped 2H Rh nanostructures with ordered vacancies. However, interstitial C atoms existed in the metallic 2H Rh-based nanomaterials. In addition, the thermostability of the metallic 2H Rh nanostructures with interstitial C atoms is poor, and phase transformation to 3C Rh occurred over 250° C. in inert atmosphere.
   According to the embodiments of the subject inventions, there are no interstitial C atoms in our synthesized 2H Rh NPLs, which is confirmed by a series of characterizations. In addition, the thermostability of the 2H Rh NPLs is excellent, and the 2H Rh NPLs are thermally stable up to about 300° C. in inert atmosphere.

According to the embodiments of the subject inventions, the compounds-derived method is provided for synthesizing 2H Rh NPLs in high yield and phase purity. The Rh₂C NPLs are employed as the starting materials due to the novel packing sequence of Rh atoms in Rh₂C as well as the relatively weak interaction between Rh and C atoms, allowing for extracting C atoms from the Rh lattice under relatively mild conditions. After the extraction of C atoms, orthorhombic phase Rh₂C NPLs transformed into 2H Rh NPLs. For the first time, pure 2H Rh nanomaterials are successfully obtained. Furthermore, 2H Rh-based alloy NPLs can be obtained by adding a second metal during the C extraction. The edge length of 2H Rh NPLs ranges from 5 nm to 50 nm and the edge width ranges from 2 to 20 nm. The thickness of the Rh NPLs is around 1-4 nm. In addition, control experiments show the ultrasmall size and 2D morphology of the Rh₂C play important roles in stabilizing the 2H phase of the derived Rh nanomaterials. When using large-size Rh₂C NFs with an average diameter of 66.5 nm as the starting materials, only 3C Rh products are obtained after the extraction of C atoms. It is noted that the thermostability study reveals that the 2H Rh NPLs remain stable after annealing treatment at 300° C. for 1 hour under an inert atmosphere, indicating that the 2H Rh NPLs are promising for various industrial applications with relatively hash conditions.

### EXEMPLARY EMBODIMENTS

Embodiment 1. A compounds-derived method for synthesizing pure 2H Rh nanomaterials, comprising:
preparing orthorhombic phase Rh₂C NPLs;
obtaining pure 2H Rh NPLs by extracting C atoms from the Rh₂C NPLs; and
obtaining 2H Rh-based alloy NPLs by simultaneously reducing the second metal during the C extraction.

Embodiment 2. The method of embodiment 1, wherein the preparing orthorhombic phase Rh₂C NPLs comprises:
dissolving a first predetermined amount of Rh(acac)₃ or RhCl₃ into a mixture solution containing a second predetermined amount oleylamine and a third predetermined amount oleic acid in a container and sonicating for a first predetermined time;
adding a fourth predetermined amount of formaldehyde into the mixture solution;
sealing the container and sonicating it for a second predetermined time;
heating the container at a first predetermined temperature for a third predetermined time; and
cooling the container to room temperature.

Embodiment 3. The method of any preceding embodiment, further comprising:
collecting the resultant products by centrifugations at 14000 rpm for 5 minutes;
washing the resultant products one or more times with a mixture of cyclohexane and ethanol (v/v=1:2); and
dispersing the resultant products in cyclohexane.

Embodiment 4. The method of any preceding embodiment, wherein the obtaining pure 2H Rh NPLs by extracting C atoms from the Rh₂C NPLs comprises:
re-dispersing the Rh₂C NPLs in a fifth predetermined amount oleylamine by sonication; and
heating the solution in an oil bath at a second predetermined temperature for a fourth predetermined time, while simultaneously flowing Ar/H₂ mixture with a first predetermined percentage of H₂ volume content bubbled into the solution at a first predetermined flow rate.

Embodiment 5. The method of any preceding embodiment, wherein the obtaining 2H Rh-based alloy NPLs by simultaneously reducing the second metal during the C extraction comprises:
re-dispersing the Rh₂C NPLs and dissolving a sixth predetermined amount of a first predetermined metal precursor in the fifth predetermined amount of oleylamine by sonication; and
heating the solution in an oil bath at a third predetermined temperature for the fifth predetermined time, while simultaneously flowing Ar/H₂ mixture with the first predetermined percentage of H₂ volume content bubbled into the solution at the first predetermined flow rate.

Embodiment 6. The method of any preceding embodiment, further comprising:
collecting the resultant products by centrifugations at 14000 rpm for 5 minutes;
washing the resultant products three times with a mixture of cyclohexane and ethanol (v/v=1:2); and
dispersing the resultant products in cyclohexane.

Embodiment 7. The method of any preceding embodiment, wherein the first predetermined amount is in a range of 1-3 mg.

Embodiment 8. The method of any preceding embodiment, wherein the second predetermined amount is about 2.25 mL.

Embodiment 9. The method of any preceding embodiment, wherein the third predetermined amount is in a range of 0.1-0.3 mL.

Embodiment 10. The method of any preceding embodiment, wherein the first predetermined time is about 5 minutes.

Embodiment 11. The method of any preceding embodiment, wherein the fourth predetermined amount is in a range of 0.7-0.8 mL.

Embodiment 12. The method of any preceding embodiment, wherein the second predetermined time is in range of 5-10 minutes.

Embodiment 13. The method of any preceding embodiment, wherein the first predetermined temperature is in a range of 160-200° C.

Embodiment 14. The method of any preceding embodiment, wherein the third predetermined time is about 12 hours.

Embodiment 15. The method of any preceding embodiment, wherein the fifth predetermined amount is in a range of 2.0-4.0 mL.

Embodiment 16. The method of any preceding embodiment, wherein the second predetermined temperature is in a range of 130-160° C.

Embodiment 17. The method of any preceding embodiment, wherein the fourth predetermined time is in a range of 16-24 hours.

Embodiment 18. The method of any preceding embodiment, wherein the first predetermined percentage is about 10%.

Embodiment 19. The method of any preceding embodiment, wherein the first predetermine flow rate is about 50 ml/minute.

Embodiment 20. The method of any preceding embodiment, wherein the sixth predetermined amount is in a range of 0.1-1 mg.

Embodiment 21. The method of any preceding embodiment, wherein the first predetermined metal precursor is Ru precursor or Pt precursor.

Embodiment 22. The method of any preceding embodiment, wherein the fifth predetermined time is in a range of 14-20 hours.

Embodiment 23. The method of any preceding embodiment, wherein the third predetermined temperature is in a range of 140-200° C.

Embodiment 24. The method of any preceding embodiment, wherein the resultant 2H Rh NPLs are configured to have an edge length range of 5 to 50 nm and an edge width range of 2 to 20 nm.

Embodiment 25. The method of any preceding embodiment, wherein the resultant 2H Rh NPLs are configured to have a thickness of about 1-4 nm.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

We claim:

1. A compounds-derived method for synthesizing 2H Rh and Rh-based alloy nanomaterials, comprising:
preparing orthorhombic phase Rh₂C NPLs;
obtaining pure 2H Rh NPLs by extracting C atoms from the Rh₂C NPLs; and
obtaining 2H Rh-based alloy NPLs by simultaneously reducing the second metal during the C extraction.

2. The method of claim 1, wherein the preparing orthorhombic phase Rh₂C NPLs comprises:
dissolving a first predetermined amount of Rh(acac)₃ or RhCl₃ into a mixture solution containing a second predetermined amount of oleylamine and a third predetermined amount of oleic acid in a container and sonicating for a first predetermined time;
adding a fourth predetermined amount of formaldehyde into the mixture solution;
sealing the container and sonicating it for a second predetermined time;
heating the container at a first predetermined temperature for a third predetermined time; and
cooling the container to room temperature.

3. The method of claim 2, further comprising:
collecting the resultant products by centrifugations at 14000 rpm for 5 minutes;
washing the resultant products one or more times with a mixture of cyclohexane and ethanol (v/v=1:2); and
dispersing the resultant products in cyclohexane.

4. The method of claim 1, wherein the obtaining pure 2H Rh NPLs by extracting C atoms from the Rh₂C NPLs comprises:
re-dispersing the Rh₂C NPLs in a fifth predetermined amount oleylamine by sonication; and
heating the solution in an oil bath at a second predetermined temperature for a fourth predetermined time, while simultaneously flowing Ar/H₂ mixture with a first predetermined percentage of H₂ volume content bubbled into the solution at a first predetermined flow rate.

5. The method of claim 1, wherein the obtaining 2H Rh-based alloy NPLs by simultaneously reducing the second metal during the C extraction comprises:
re-dispersing the Rh₂C NPLs and dissolving a sixth predetermined amount of a first predetermined metal precursor in the fifth predetermined amount of oleylamine by sonication; and
heating the solution in an oil bath at a third predetermined temperature for a fifth predetermined time, while simultaneously flowing Ar/H₂ mixture with the first predetermined percentage of H₂ volume content bubbled into the solution at the first predetermined flow rate.

6. The method of claim 4, further comprising:
collecting the resultant products by centrifugations at 14000 rpm for 5 minutes;
washing the resultant products three times with a mixture of cyclohexane and ethanol (v/v=1:2); and
dispersing the resultant products in cyclohexane.

7. The method of claim 5, further comprising:
collecting the resultant products by centrifugations at 14000 rpm for 5 minutes;
washing the resultant products three times with a mixture of cyclohexane and ethanol (v/v=1:2); and
dispersing the resultant products in cyclohexane.

8. The method of claim 2, wherein the first predetermined amount is in a range of 1-3 mg.

9. The method of claim 2, wherein the second predetermined amount is about 2.25 mL.

10. The method of claim 2, wherein the third predetermined amount is in a range of 0.1-0.3 mL.

11. The method of claim 2, wherein the first predetermined time is about 5 minutes.

12. The method of claim 2, wherein the fourth predetermined amount is in a range of 0.7-0.8 mL.

13. The method of claim 2, wherein the second predetermined time is in range of 5-10 minutes.

14. The method of claim 2, wherein the first predetermined temperature is in a range of 160-200° C.

15. The method of claim 2, wherein the third predetermined time is about 12 hours.

16. The method of claim 4, wherein the fifth predetermined amount is in a range of 2.0-4.0 mL.

17. The method of claim 4, wherein the second predetermined temperature is in a range of 130-160° C.

18. The method of claim 4, wherein the fourth predetermined time is in a range of 16-24 hours.

19. The method of claim 4, wherein the first predetermined percentage is about 10%.

20. The method of claim 4, wherein the first predetermined flow rate is about 50 ml/minute.

21. The method of claim 5, wherein the sixth predetermined amount is in a range of 0.1-1 mg.

22. The method of claim 5, wherein the first predetermined metal precursor is Ru precursor or Pt precursor.

23. The method of claim 5, wherein the third predetermined temperature is in a range of 140-200° C. 24 The method of claim 5, wherein the fifth predetermined time is in a range of 14-20 hours.

25. The method of claim 1, wherein the resultant 2H Rh NPLs are configured to have an edge length range of 5 to 50 nm and an edge width range of 2 to 20 nm.

26. The method of claim 1, wherein the resultant 2H Rh NPLs are configured to have a thickness of about 1-4 nm.
